(19) United States
(12) Patent Application Publication
(10) Pub. No.: US 2024/0409770 A1
(43) Pub. Date: Dec. 12, 2024

(54) SOLVENT-BORNE ACID-CURING COATING COMPOSITION AND COATED ARTICLE

(71) Applicant: GUANGDONG HUARUN PAINTS CO., LTD., Guangdong (CN)

(72) Inventors: Wei YANG, Foshan City (CN); Mijin ADIKKALATHIL, Foshan City (CN)

(21) Appl. No.: 18/701,640

(22) PCT Filed: Oct. 25, 2022
(86) PCT No.: PCT/CN2022/127188

§ 371 Date: Apr. 16, 2024

(30) Foreign Application Priority Data
Nov. 9, 2021 (CN) 202111321301.0

(51) Int. Cl. C09D 167/08; C08K 5/5419; C09D 7/20; C09D 7/63

(52) U.S. Cl. CPC C09D 167/08; C08K 5/5419; C09D 7/20; C09D 7/63

(57) ABSTRACT

The present application relates to a solvent-borne acid-curing coating composition and coated article therefrom. In particular, the solvent-borne acid-curing coating composition comprises at least one film-forming composition, the at least one film-forming composition comprising at least one hydroxyl functional resin, at least one amino resin, and at least one acid catalyst, wherein the solvent-borne coating composition further includes at least one amino-functional silane.

### CROSS REFERENCE TO RELATED APPLICATION

This application claims priority to the Chinese Patent Application No. 202111321301.0 entitled “SOLVENT-BORNE ACID-CURING COATING COMPOSITION AND COATED ARTICLE” and filed on Nov. 9, 2021, which is incorporated herein by reference in its entirety.

### TECHNICAL FIELD

The present application relates to a solvent-borne acid-curing coating composition and coated article therefrom. More specifically, the present application relates to a solvent-borne acid-curing coating composition with excellent coating performances in high humidity environment and a coated article made therefrom.

### BACKGROUND

Acid-curing (AC) coating is a kind of coating previously applied in the coating industry, where an acid catalyst is used to accelerate the cross-linking and curing of an amino resin and a hydroxyl functional resin. The AC coating has the advantages of hard and wear-resistant paint films; high heat, water and cold resistance of paint films; good transparency; good yellowing resistance; and no isocyanates compared to solvent-borne two-component (2K) polyurethane (PU) coatings. Therefore, the acid-curing coating compositions are well suited for the coating of wood substrates, especially for furniture wood.

In recent years, there has been an increasing demand for acid-curing coating compositions. However, in high humidity environments, such as those regions in Southeast Asia and Southern China, and other regions during the rainy season, such acid-curing coating compositions suffer from the issue of blushing, rendering the application of acid-curing systems to be limited significantly.

For this reason, there is a need for an improved acid-curing coating composition in the coatings industry, especially one that is suitable for extremely high humidity environments.

### SUMMARY

The present application provides, in one aspect, a solvent-borne acid-curing coating composition comprising at least one film-forming composition, said at least one film-forming composition comprising at least one hydroxyl-functional resin, at least one amino resin, and at least one acid catalyst, wherein said solvent-borne coating composition further comprises at least one amino-functional silane. Preferably, said coating composition further comprises, relative to the total weight of said film-forming composition, 0.2-2 wt. % of said at least one amino-functional silane.

The present application further provides an article, said article comprising a substrate having at least one major surface; and a coating applied directly or indirectly to at least a portion of said major surface of said substrate, wherein said coating is formed from the solvent-borne acid-curing coating composition of the present application. Preferably, said substrate is selected from wood, wood composite, paper, metal, plastic, fabric, ceramic, cementious material, or any combination thereof.

It was surprisingly discovered that in the formulation of solvent-borne acid-curing coating compositions, particularly in the formulation of acid-curing coating compositions comprising at least one hydroxyl-functional resin, at least one amino compound and at least one acid catalyst, by adding a specific amount of at least one amino-functional silane, it is possible to solve the issue of the above-mentioned acid-curing system being prone to blushing when applied under high humidity environments, even under extremely high humidity environments with a humidity of 85% or higher), which was difficult to anticipate prior to the present application. The resulting coating composition is not only substantially free of blushing upon film-forming under high humidity conditions, but also produces coatings with a high gloss.

Moreover, it was surprisingly found that the solvent-borne acid-curing coating composition formed by adding a specific amount of at least one amino-functional silane to an acid-curing coating composition comprising at least one hydroxyl-functional resin, at least one amino compound, and at least one acid catalyst could pass one or more, preferably more than one, more preferably all of shrinkage and heat resistance, cold and heat check resistance, chemical resistance, and detergent and water resistance as specified by the Cabinetry Association of America (KCMA), and further pass one or more, preferably more than one, more preferably all of more harsh testing programs as specified by cabinet buyers such as MBCI-Master Brand, such as high/low humidity testing, heat resistance testing, cold resistance testing, cross hatch test, accelerated UV/heat exposure test, profile and joint Finish adhesion tape testing, wet towel finish Test, Mar Test, and high temperature dark storage yellowing test, wherein these testing programs are as disclosed in the following examples section.

Details of one or more embodiments of the present application are set forth in the following specification. Other features, purposes and advantages of the present application will become clear in light of the specification and claims.

### DEFINITION

As used herein, “a”, “an”, “the”, “at least one”, and “one or more” are used interchangeably. Thus, for example, a coating composition that comprises “an” additive can be interpreted to mean that the coating composition includes “one or more” additives. Unless otherwise noted herein, the use of the singular form in the present application is also intended to include the plural form.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this application, as along as such components or steps do not affect the basic and novel characteristics of the application, but it is also contemplated that the compositions or processes may consist essentially of, or consist of, the recited components or steps.

In the present application, the range of values recited by endpoints includes all values within that range. For example the range 1 to 5 covers the values of 1, 1.5, 2, 2.75, 3, 3.80, 4, 5, and the like. Further, the disclosed range of values includes all subset ranges within that wider range, e.g., the range of 1 to 5 includes sub ranges of 1 to 4, 1.5 to 4.5, 1 to 2, and the like.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

When used in connection with a “solvent-borne acid-curing coating composition”, the term “film-forming composition” refers to such a composition that contains not only a resin component and an acid catalyst, but also other components suitable for an acid-curing coating composition, such as solvents and additional additives, and the like, and that is capable of forming a non-tacky continuous film on said substrate when the composition, when mixed, is applied to a substrate and then is dried, cross-linked or otherwise hardened.

As used herein, the term “amino resin” refers to a product formed by condensation of an amino compound, i.e., a compound containing at least one primary amine (NH₂) functional group and/or an amide (—CO—NH₂) functional group, with an aldehyde compound, optionally partially or fully etherified by an aliphatic monohydric alcohol.

When used in connection with a “hydroxyl-functional resin”, the term “hydroxyl value” refers to the number of milligrams of potassium hydroxide that corresponds to the hydroxyl content per gram of the hydroxyl-functional resin. The hydroxyl value can be determined by methods well known in the art. For example, the hydroxyl value is determined according to the standard GB/T 12008.3-2009.

When used in connection with a “coatings formed by solvent-borne acid-curing coating compositions”, the term “substantially free of blushing” means that the coating shows essentially no visible color change observed by the naked eye during its film formation process at a humidity level of 85% or higher according to ASTM D1735. In some preferred embodiments of the present application, the term “substantially free of blushing” means that the coating shows essentially no visible color change observed by the naked eye during its film formation and storage for e.g., 1 month or longer, 3 months or longer, 6 months or longer at a humidity level of 85% or higher.

As used herein, “coating” has the same meaning as “paint film”, which are formed by the application and curing of a solvent-borne acid-curing coating composition.

The terms “preferred” and “preferably” refer to embodiments of the application that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the application.

### DESCRIPTION OF DRAWINGS

FIG. 1 is a comparison of the coating formed by the solvent-borne acid-curing coating composition of Comparative Example 1 of the present application and the coating formed by the solvent-borne acid-curing coating composition of Example 1 of the present application, where the coating in a. is obtained from Comparative Example 1 and has obvious blushing regions, and the coating in b. is obtained from Example 1, which are uniform and free of blushing.

### DETAILED DESCRIPTION

The present application provides, on the one hand, a solvent-borne acid-curing coating composition comprising at least one film-forming composition, said at least one film-forming composition comprising at least one hydroxyl-functional resin, at least one amino resin and at least one acid catalyst, wherein said solvent-borne coating composition further comprises at least one amino-functional silane.

An acid-curing coating composition has been suffering from the problem of construction blushing under a high humidity environment. To solve the blushing problem, field applicators usually add retarders, such as slow-drying solvents, to the coating composition to allow the solvent to evaporate at a reduced rate from the surface of wet film and to prevent a “cold bed” from forming. However, in environments with particularly high humidity, such as Southeast Asia where the humidity is 85% or higher, this solution is limited and the problem of blushing of the paint film still exists, requiring the application to be stopped until temperature and humidity of the environment are lowered, which inevitably reduces productivity and inevitably produces problems of blocking of coatings during their lamination, packaging, transportation, and the like.

It was surprisingly discovered that in the formulation of solvent-borne acid-curing coating compositions, particularly in the formulation of acid-curing coating compositions comprising at least one hydroxyl-functional resin, at least one amino compound and at least one acid catalyst, by adding a specific amount of at least one amino-functional silane, it is possible to solve the issue of the above-mentioned acid-curing system being prone to blushing when applied under high humidity environments, defined as environments with a humidity of 85% or higher, as tested according to ASTM D1735. The resulting coating composition is not only substantially free of blushing upon film-forming under high humidity conditions, but also produces coatings with a high gloss. Moreover, it was surprisingly discovered that in the formulation of solvent-borne acid-curing coating compositions, the addition of epoxy-functional silane, which is common in the coating field, could not solve the issue of the above-mentioned acid-curing system being prone to blushing when applied under high humidity environments with a humidity of 85% or higher. As can be seen, amino-functional silane can specifically solve the issue of the above-mentioned acid-curing system being prone to blushing when applied under high humidity environments with a humidity of 85% or higher, which was unforeseen prior to the present application.

It was surprisingly found that the solvent-borne acid-curing coating composition formed by adding a specific amount of at least one amino-functional silane to an acid-curing coating composition comprising at least one hydroxyl-functional resin, at least one amino compound, and at least one acid catalyst could pass one or more, preferably more than one, more preferably all of shrinkage and heat resistance, cold and heat check resistance, chemical resistance, and detergent and water resistance as specified by the Cabinetry Association of America (KCMA), and further pass one or more, preferably more than one, more preferably all of more harsh testing programs as specified by cabinet buyers such as MBCI-Master Brand, such as high/low humidity testing, heat resistance testing, cold resistance testing, cross hatch test, accelerated UV/heat exposure test, profile and joint Finish adhesion tape testing, wet towel finish Test, Mar Test, and high temperature dark storage yellowing test, wherein these testing programs are as disclosed in the following examples section.

Thus, in embodiments according to the present application, said solvent-borne acid-curing coating composition further comprises at least one amino-functional silane. As used herein, an amino-functional silane is a silane containing at least one amino functional group, which may be in the form of a monomer or an oligomer, or even in the form of a polymer. In a preferred embodiment of the present application, said amino-functional silane is diamino-functional.

In an embodiment according to the present application, the solvent-borne acid-curing coating composition comprises at least one amino-functional silane, said at least one amino-functional silane being in the form of a monomer. By way of exemplary illustration, said amino-functional silane is a silane compound having the structure shown in the following formula (I).

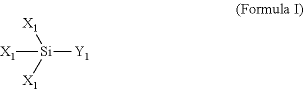

wherein each X₁ is independently —Cl, —OCH₃, —OCH₂CH₃, —OC₂H₄OCH₃, —OSi(CH₃)₃, or —OCOCH₃; and Y₁ is an alkyl group substituted with —NH₂. Preferably, said silane compound comprises 3-aminopropyltrimethoxysilane, 3-aminopropyltriethoxysilane, 3-aminopropyltripropoxysilane.

In another embodiment according to the present application, the solvent-borne acid-curing coating composition comprises at least one amino-functional silane, said at least one amino-functional silane being in the form of an oligomer, for example in the form of an aqueous solution of the oligomer. By way of exemplary illustration, said amino-functional silane is an oligomeric silane having the structure shown in formula I) below.

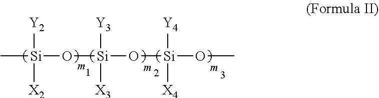

where each of X₂, X₃ and X₄ is independently selected from —Cl, —OCH₃, —OCH₂CH₃, —OC₂H₄OCH₃, —OSi(CH₃)₃, —OCOCH₃, —H, —CH₃, —C₂H₅, and —OH with the proviso that at least one of X₂, X₃ and X₄ is not —H, —CH₃, —C₂H₅, or —OH; at least one of Y₂, Y₃ and Y₄ is an alkyl group substituted with —NH₂; and each of m₁, m₂ and m₃ independently is from 0 to 200, with the proviso that at least one of m₁, m₂ and m₃ is not 0. Preferably, each of Y₂, Y₃ and Y₄ is an alkyl group substituted with —NH₂.

Preferably, the amino-functional silane in the form of oligomer has a certain neutral equivalent. As used herein, the term “neutral equivalent” refers to the mass of an amino-functional silane containing 1 equivalent of an amino group. Generally, the lower the neutral equivalent, the more amino groups are contained in the amino-functional silane and the more active it is. The neutral equivalent of an amino-functional silane can be between 100 g/eq and 200 g/eq, e.g. 105-150 g/eq. The neutral equivalent is calculated from an amine value according to the following formula: neutral equivalent=56.1×1000/[amine value], where the amine value can be determined according to ASTMD2074.

The source of the above-disclosed amino-functional silanes are well known and generally commercially available.

In embodiments according to the present application, the amount of amino-functional silane can be selected as desired. Generally, the amount of amino-functional silane should not adversely effect any properties of the coating composition. Preferably, the amount of amino-functional silane may be up to 5 wt. %, preferably up to 4 wt. %, further preferably up to 3 wt. %, relative to the total weight of said film-forming composition. However, the amount of amino-functional silane in the coating composition should not be too low; otherwise it will not solve the issue of the acid-curing coating composition system being prone to blushing when applied under high humidity environments according to ASTM D1735. Preferably, the amount of amino-functional silane may be at least 0.1 wt. %, preferably at least 0.15 wt. %, further preferably 0.2 wt. % or higher, relative to the total weight of said film-forming composition.

In some embodiments of the present application, the amount of said at least one amino-functional silane is in the range of 0.2 wt. % to 2 wt. %, preferably in the range of 0.3 wt. % to 1 wt. %, more preferably in the range of 0.4 wt. % to 0.8 wt. %, relative to the total weight of said film-forming composition.

In embodiments according to the present application, the acid-curing coating composition further comprises a film-forming composition in addition to the amino-functional silane described above. As used herein, the film-forming composition refers to such a composition that is capable of forming main body of coating formed by the acid-curing coating composition, which contains not only at least one resin component and at least one acid catalyst, but also at least one solvent as well as additional additives.

In the acid-curing coating composition according to the present application, the film-forming composition comprises at least one hydroxyl-functional resin and at least one amino resin, which, as a resin component or a part of a resin component, form main body of coating formed by the acid-curing coating composition so as to provide sufficient mechanical strength for the resulting coating.

In some embodiments according to the present application, said hydroxyl-functional resin may include, for example, at least one hydroxyl-functional epoxy, at least one hydroxyl-functional polyurethane, at least one hydroxyl-functional polyester, at least one hydroxyl-functional polyether, at least one hydroxyl-functional alkyd resin, at least one hydroxyl-functional acrylics resin, or combinations thereof. In the presently preferred embodiment, the hydroxyl-functional resin may include at least one hydroxyl-functional acrylics resin, an alkyd resin, or a combination thereof, preferably at least one hydroxyl-functional alkyd resin.

In an embodiment according to the present application, the hydroxyl-functional resin has a hydroxyl value not higher than 300 mg KOH/g according to ISO 4629, preferably in the range of 50-280 mg KOH/g, more preferably in the range of 50-250 mg KOH/g, still more preferably in the range of 80-200 mg KOH/g, even more preferably in the range of 80-150 mg KOH/g, so that the desired curing effect can be achieved. Said hydroxyl value is measured with titration according to ISO 4629. If the hydroxyl value of the hydroxyl-functional resin is too high (for example, over 400 mg KOH/g), it gels too quickly after mixing with an amino resin and is not suitable for construction operations; if the hydroxyl value of the hydroxyl-functional resin is too low, its curing reaction with an amino resin is too slow, resulting in reduced construction efficiency. Therefore, in some embodiments according to the present application, the hydroxyl value of the hydroxyl-functional resin is appropriate within the above-mentioned range, which makes the coating composition formulated therefrom with a suitable pot life.

In an embodiment according to the present application, the hydroxyl-functional resin has a suitable molecular weight in order to provide sufficient mechanical strength to the resulting coating system. Preferably, said at least one hydroxyl-functional resin has a weight average molecular weight greater than 50,000 g/mol, preferably in the range of 50,000 g/mol to 120,000 g/mol. If the molecular weight of the hydroxyl-functional resin is too high, the coating composition formulated therefrom would be difficult to be coated uniformly and is not suitable for construction operation; if the molecular weight of the hydroxyl-functional resin is too low, the coating composition formulated therefrom render the resulting paint film formed to have limited strength. Therefore, in some embodiments according to the present application, the molecular weight of the hydroxyl-functional resin is appropriate in the above-mentioned range.

In some embodiments according to the present application, a hydroxyl-functional acrylics resin is used as a hydroxyl-functional resin. The hydroxyl-functional acrylics resin meeting the above performance requirements can be made, for example, by techniques known to those of ordinary skill in the art. For example, the hydroxyl-functional acrylic resin can be hydroxyl-containing copolymers of ethylenically unsaturated compounds. These copolymers are copolymers of olefin monomers containing hydroxyl groups with olefin monomers that do not contain hydroxyl groups. Examples of suitable monomers include vinyl and vinylidene monomers such as styrene, alpha-methylstyrene, o- and p-chlorostyrene, o-, m- and p-methylstyrene, p-tert-butylstyrene, acrylic acid, (meth)acrylonitrile, acrylic and methacrylic esters having 1 to 8 carbon atoms (e.g., ethyl acrylate, methyl acrylate, n- or isopropyl acrylate, n-butyl acrylate, 2-ethylhexyl acrylate, 2-ethylhexyl methacrylate, isooctyl acrylate, methyl methacrylate, ethyl methacrylate, butyl methacrylate and isooctyl methacrylate); diesters of fumaric, itaconic or maleic acid with an alcohol component having 4 to 8 carbon atoms; (meth)acrylate amides; vinyl esters of alkyl monocarboxylic acids with 2 to 5 carbon atoms (e.g. vinyl acetate or vinyl propionate) and hydroxyalkyl esters of acrylic or methacrylic acid having from 2 to 4 carbon atoms in its hydroxyalkyl moiety (e.g. 2-hydroxyethyl acrylate or methacrylate, 2-hydroxypropyl acrylate or methacrylate, 4-hydroxybutyl acrylate or methacrylate, trimethylolpropane monoacrylate or methacrylate or pentaerythritol monoacrylate or methacrylate). Mixtures of these monomers can also be used to prepare the hydroxyl-functional acrylics resin.

As an example of a hydroxyl-functional acrylic resin, any conventional hydroxyl-functional acrylic resin can be used.

In some other embodiments according to the present application, a hydroxyl-functional alkyd resin is used as a hydroxyl-functional resin. As used herein, the term “alkyd resin” refers to a liquid alkyd resin made by condensation polymerization of a polyol, a polyacid or anhydride together with an unsaturated fatty acid; or by trans-esterification of a polyol with a fatty oil, which is also referred to as a fatty acid or fatty oil modified polyester. Representative polyols include glycerol, pentaerythritol, sorbitol, trimethylolpropane, ethylene glycol, diethylene glycol, propylene glycol, dipropylene glycol, and other polyols known to those of ordinary skill in the art to be used in the preparation of alkyd resins. Representative polyacids or anhydrides include dibasic acids or anhydrides such as phthalic acid and its anhydride, isophthalic acid, terephthalic acid, maleic acid, fumaric acid, adipic acid, sebacic acid, and the like; ternary acids such as trimellitic acid; and other polyacids or anhydrides known to those of ordinary skill in the art for use in the preparation of alkyd resins. Representative fatty acids include dehydrated castor fatty acids, flax fatty acids, castor fatty acids, soy fatty acids, and combinations thereof. Representative fatty oils include vegetable oils such as carona oil, castor oil, dehydrated castor oil, coconut oil, corn oil, cottonseed oil, groundnut oil, linseed oil, peanut oil, safflower oil, soybean oil, sunflower oil, tall oil, tung oil, walnut oil, wood oil, and the like; animal fats such as fish oil, lard, chicken oil, tallow, and the like; and combinations thereof.

As described above, the alkyd resins can be prepared by suitable preparation methods known to those of ordinary skill in the art, or can be obtained from any suitable commercially available product. As examples of alkyd resins, alkyd resins such as long oil alkyd resins may be used.

In one embodiment according to the present application, the amount of the hydroxyl-functional resin may vary over a wide range. For example, the hydroxyl-functional resin may be no more than 69 wt. %, no more than 65 wt. %, no more than 60 wt. %, and at least 20 wt. %, at least 30 wt. %, at least 35 wt. %, at least 40 wt. %, relative to the total weight of said film-forming composition. In a preferred embodiment according to the present application, the hydroxyl-functional resin is present in an amount in the range of 20 to 69 wt. %, preferably in the range of 20 to 40 wt. %, relative to the total weight of the film forming composition. Typically, the desired amount of hydroxyl-functional resin may be selected empirically, typically based on the film-forming properties of the paint film.

In some embodiments according to the present application, the film-forming composition comprises an amino resin in addition to the hydroxyl-functional resin described above.

As mentioned above, the amino resin is a condensation product of aldehydes (e.g., formaldehyde, acetaldehyde, crotonaldehyde, and benzaldehyde) and amino compounds containing amino or amide groups (e.g., urea, melamine, phenyl-substituted melamine, or methyl melamine). Other condensation products of amines and amides, such as aldehyde condensates of triazine, diazine, triazole, guanidine, guanidinium, and alkyl-substituted and aryl-substituted melamines, can also be used. Some examples of such compounds are N,N′-dimethylurea, benzoylurea, dicyandiamide, methylguanidine, ethylguanidine, glycylurea, melamine diamide, 2-chloro-4,6-diamino-1,3,5-triazine, 6-methyl-2,4-diamino-1,3,5-triazine, 3,5-diaminotriazole, triamino-pyrimidine, 2-mercapto-4,6-diamino-pyrimidine, 3,4,6-tris(ethylamino)-1,3,5-triazine, and the like. Although the aldehyde used is usually formaldehyde, other aldehydes may be used, such as acetaldehyde, crotonaldehyde, acrolein, benzaldehyde, furfural, glyoxal, and mixtures thereof. In the presently preferred embodiment of the present application, melamine-formaldehyde, phenyl-substituted melamine-formaldehyde, glyoxal-formaldehyde, methyl melamine-formaldehyde, or combinations thereof are used as the amino resin.

In some preferred embodiments according to the present application, the amino resin may be optionally partially alkylated. In some embodiments, the amino resin is an amino resin etherified by n-butanol, an amino resin etherified by isobutanol, an amino resin etherified by methanol, or any combination thereof. Particularly preferably, the amino resin according to some embodiments of the present application comprises an amino resin that is not fully etherified.

The amino resins are commercially available, and non-limiting examples of suitable amino resins may include but are not limited to highly methylated monomeric melamine crosslinker, highly methylated/ethylated benzoguanamine resin, highly butylated glycoluril crosslinker, or combinations thereof.

The amount of amino resin may depend on various factors including, for example, the type of amino resin, the time and temperature of baking, the molecular weight of the hydroxyl-functional resin, and the desired coating properties. Based on the total weight of the film-forming composition, the amino resin is typically present in an amount of up to 60 wt. %, preferably up to 55 wt. %, more preferably up to 50 wt. %, and in an amount of at least 20 wt. %, at least 25 wt. %, at least 30 wt. %, or at least 35 wt. %. In a preferred embodiment according to the present application, the amount of amino resin, relative to the total weight of the film forming composition, is in the range of 20 to 50 wt. %, preferably in the range of 20 to 40 wt. %, more preferably in the range of 20 to 30 wt. %. Typically, the desired amount of amino resin can be selected empirically based on the film-forming properties of the paint film.

In addition, in embodiments according to the present application, the acid-curing coating composition may further comprise at least one acidic catalyst. Examples of acidic catalysts include, but are not limited to, p-toluenesulfonic acid, benzenesulfonic acid, methanesulfonic acid, dinonylnaphthalenesulfonic acid, dinonylnaphthalenedisulfonic acid, dodecylbenzenesulfonic acid, oxalic acid, maleic acid, phthalic acid, acrylic acid, mono(di)alkyl phosphate, phosphoric acid, mono(di)alkyl pyrophosphate, or combinations thereof.

In the solvent-borne acid-curing coating compositions according to the present application, the amount of the acidic catalyst can be adjusted as desired empirically by those skilled in the art, in particular according to the amount of hydroxyl-functional resin and/or amino resin. In some embodiments of the present application, the acidic catalyst is present in an amount of at most 15 wt. %, at most 13 wt. %, at most 12 wt. %, at most 10 wt. %, at most 8 wt. %, at most 5 wt. %, and at least 0.1 wt. %, at least 0.2 wt. %, at least 0.5 wt. %. In some preferred embodiments of the present application, the acidic catalyst is present in an amount in the range of 0.1-10 wt. %, preferably in the range of 0.2-8 wt. %, more preferably in the range of 0.2-6 wt. %. These weight percentages are determined based on the total weight of the film-forming composition.

In some embodiments according to the present application, the solvent-borne acid-curing coating composition may comprise an organic solvent to further modulate viscosity of the coating composition. The addition of the organic solvent can increase evaporation rate of the coating composition and accelerate formation of the paint film. In some embodiments of the present application, said organic solvents include ketones (e.g. acetone, methyl isopropyl ketone, methyl isobutyl ketone, etc.), esters (ethyl acetate, butyl acetate, etc.), aromatics (toluene, xylene, etc.), aliphatic hydrocarbons (cyclopentane, cyclohexane, etc.), or any combination thereof.

In a preferred embodiment according to the present application, the solvent, if present, can be, for example, at least 0.1 wt. %, at least 1 wt. %, at least 3 wt. %, at least about 5 wt. %, at least about 6 wt. %, at least about 7 wt. %, at least about 8 wt. %, at least about 9 wt. %, at least about 10 wt. % of the total weight of the film-forming composition. In a preferred embodiment according to the present application, the solvent, if present, may be, for example, up to about 25 wt. %, up to about 20 wt. %, up to about 19 wt. %, up to about 18 wt. %, or up to about 17 wt. % of the total weight of the film-forming composition. Typically, the desired solvent amount is typically selected empirically based on film forming properties of the paint film.

In some embodiments according to the present application, the film-forming composition in the solvent-borne acid-curing coating composition may also comprise optional additional additives, said optional additional additives being those commonly used in coating compositions. These additives do not adversely affect the coating composition or the cured coating obtained therefrom. Suitable additives include, for example, those agents that will improve processing or manufacturing properties of the composition, enhance aesthetics of the composition, or improve specific functional properties or characteristics of the coating composition or the cured composition obtained therefrom, such as adhesion to the substrate. Depending on specific needs, additives may include in the film forming composition such as, but not limited to, anti-caking agents, drying agents, film forming aids, coupling agents, pigments, fillers, anti-settling agents, anti-migration aids, antimicrobial agents, anti-mold agents, lubricants, wetting agents, biocides, plasticizers, defoamers, colorants, waxes, antioxidants, anti-corrosion agents, rheology aids, dispersants, adhesion promoters, UV stabilizers, leveling agents, or combinations thereof. The amount of each optional ingredient is sufficient to serve its intended purpose, but preferably in such a way that it does not adversely affect the coating composition or the cured coating obtained therefrom. Preferably, the additional additives comprise pigments, fillers, thickeners, anti-settling agents, dispersants, wetting agents, film forming aids, coupling agents, fungicides, anti-mold agents or any combination thereof.

In some embodiments according to the present application, the total amount of additional additives is in the range of about 0 wt. % to about 30 wt. %, preferably in the range of about 0.1 wt. % to about 30 wt. %, relative to the total weight of the film-forming composition.

In a specific embodiment according to the present application, the film-forming composition of the solvent-borne acid-curing coating composition comprises, relative to the total weight of said film-forming composition,
20-69 wt. % of said at least one hydroxyl-functionalized resin,
20-50 wt. % of said at least one amino resin,
0.1-10 wt. % of said at least one acidic catalyst,
0.1-20 wt % of at least one solvent; and
0-30 wt % of said additional additives, said additional additives comprising at least one pigment, at least one filler, at least one thickener, at least one dispersant, at least one wetting agent, at least one film forming aid, at least one coupling agent, at least one fungicide, at least one anti-mold agent or any combination thereof.

The solvent-borne acid-curing coating compositions of the present application can be prepared by any suitable mixing method known to those of ordinary skill in the art. For example the coating composition can be made by adding a hydroxyl-functionalized resin, an amino resin, an acid catalyst, a solvent, and additional additives, if any, to a container and then mixing the resulting mixture well to form a film-forming composition. The amino-functional silane is then mixed with the film-forming composition described above, thereby forming a solvent-borne acid-curing coating composition in the form of a mixture.

In some embodiments according to the present application, the solvent-borne acid-curing coating composition so formed is applied to a substrate at a humidity of 85% or higher and the resulting coating upon drying at room temperature (about 21° C.) is substantially free of blushing according to ASTM D1735.

In some embodiments according to the present application, the solvent-borne acid-curing coating composition so formed is applied to a substrate at a humidity of 85% or higher and the resulting coating upon drying at room temperature (about 21° C.) has a gloss level in the range of 11-13 sheen at 60° according to ASTM D523.

In some embodiments according to the present application, the solvent-borne acid-curing coating composition so formed is applied to a substrate at a humidity of 85% or higher and the resulting coating upon drying at room temperature (about 21° C.) passes one or more, preferably more than one, of the test items as specified by the Cabinetry Association of America (KCMA), wherein said test items are as disclosed in the following examples section.

In some embodiments according to the present application, the solvent-borne acid-curing coating composition so formed is applied to a substrate at a humidity of 85% or higher and the resulting coating upon drying at room temperature (about 21° C.) passes one or more, preferably more than one, of the test items as specified by KCMA-MBCI, wherein said test items are as disclosed in the following examples section.

In embodiments according to the present application, the solvent-borne acid-curing coating composition according to embodiments of the present application is suitable for a wide range of application sites, not only for application sites with low humidity conditions, medium humidity conditions and high humidity conditions, but also for application sites with very high humidity conditions. Thus, it is of great value for promotion in regions and countries with high year-round humidity, such as those in Southeast Asia.

According to a second aspect of the present application, there is provided an article, said article comprising: a substrate having at least one major surface; and a coating at least partially applied directly or indirectly on the at least one major surface of the substrate, wherein the coating is formed by the solvent-borne acid-curable coating composition as described above.

In some embodiments according to the present application, said substrate is selected from wood, wood composite, paper, metal, plastic, fabric, ceramic, cementious material, or any combination thereof.

In some preferred embodiments according to the present application, the above-mentioned solvent-borne acid-curing coating composition is particularly suitable for coating onto a wooden substrate to form a wood product. Any suitable wood substrate known in the art may be used as a wood substrate for the manufacture of the wood product. As used herein, the term “wood substrate” refers to any cellulose/lignin material derived from the hard, fibrous structural tissue of the stems and roots of trees or other woody plants. Wood includes, for example, hardwood and softwood timber cut directly from trees, as well as engineered wood composites made from wood strips, wood scraps, wood fibers, or wood laminates. Examples of wood composites include, but are not limited to, plywood, oriented strand board (OSB), medium density fiberboard (MDF), scrap board, and the like.

As exemplary wood substrates, one or more of Kenwood, Chestnut, Oak, Red Hook Chestnut, Oleander, Presswood, Douglas Fir, Japanese Willow Fir, American Flat Cedar, Japanese Red Pine, Japanese Flat Cypress, Water Walnut, Black Walnut, Maple, Japanese Beech, Japanese Paulownia, Birch, Brach Double, Magnolia, Ash, Teak, Quercus, Liriodendron, Mountain Camphor, Fir, Oak, and Rubberwood may be used. Other wood substrates are also contemplated.

According to embodiments of the present application, the wood article thus obtained can be used in applications including, but not limited to: household furniture, such as tables, chairs, cabinets, etc.; bedroom and bathroom furniture; office furniture; custom furniture, such as school and children's furniture, hospital furniture, restaurant and hotel furniture, kitchen cabinets and furniture; panels for interior design; interior and exterior windows and doors; interior and exterior window frames and door frames; exterior and interior siding and wood flooring.

### EXAMPLES

The following examples describe the present application in more detail, which are for illustrative purposes only. The embodiments of the present application are not limited to these specific examples. Unless otherwise indicated, all parts, percentages, and ratios reported in the following examples are on a weight basis and all reagents used in the examples are commercially available and may be used without further treatment.

### Test Methods

Unless otherwise noted, the following test methods are used in the present application.

### Hydroxyl Value

This test was used to measure activity of hydroxyl-functional resins. The hydroxyl value of hydroxyl-functional resins was determined by titration according to ISO 4629.

### Blushing Resistance

This test was used to measure curing performances of a coating composition in a high humidity environment according to ASTM D1735. After mixing components of the solvent-borne acid-curing coating composition according to the present application, the resulting mixture was applied to a support test plate at a wet film thickness of 100-150 microns at 85% humidity and cured at room temperature (about 21° C.) for 24 hours. The curing process was maintained at 85% humidity throughout. The resulting coating was then visually inspected for blushing.

### Glossiness

This test was used to measure gloss level of cured coating. After mixing components of the solvent-borne acid-curing coating composition according to the present application, the resulting mixture was applied to a support test plate at a wet film thickness of 100-150 microns at 85% humidity and cured at room temperature (about 21° C.) for 24 hours. The 60° gloss was then evaluated using a Sheen small-aperture gloss meter according to ASTM D523.

### Shrinkage and Heat Resistance of KCMA

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form samples to be tested.

The sample was placed in a test chamber at 120° F.±5° F. and 70%±5% relative humidity for 24 hours. The sample was removed and allowed to stabilize at original room temperature (about 21° C.) and humidity (30% to 50% relative humidity) conditions.

The sample was considered to have passed the test if there was no discoloration of the finish and no signs of blistering, cracking or other film failure, as observed by visual inspection as per MBCI Test Protocol 10-10-10 Rev. No: 3. If failure occurred during initial inspection, the sample to be tested was allowed to stand for 14 days and then was visually inspected again for the same performance requirements described above.

Cold and heat check resistance of KCMA

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

The sample to be tested was placed in a test chamber at 120° F.±5° F. and 70%±5% relative humidity for 1 hour. The sample was removed for 0.5 hours to allow it to reach original room temperature (about 21° C.) and humidity (30%-50% relative humidity) conditions. The sample to be tested was then placed in a cold chamber at −5° F.±5° F. for 1 hour. The sample to be tested was removed and brought to its original room temperature (about 21° C.) and humidity (30% to 50% relative humidity) conditions. The above process was repeated for a total of 5 cycle.

The sample to be tested was considered to have passed the test if there is no discoloration of the finish and no blistering, cold cracking, or other signs of film failure as per the observation procedure of MBCI Test Protocol 10-10-10 Rev. No: 6. If failure occurred during initial inspection, the sample was allowed to stand for 14 days and then checked again for the same performance requirements as described above.

### Chemical Resistance of KCMA

After mixing components of the solvent based acid-curing coating composition according to the present application, the resulting mixture was applied to a wood substrate at a wet film thickness of 100-150 microns at 85% humidity and cured at room temperature (about 21° C.) for 24 hours to form the samples to be tested.

With the sample to be tested in a normal vertical position, 3 cc of each of the following test materials were placed on each of the four surfaces to be tested: white distilled vinegar (5% acidity), 100% lemon juice (made from concentrate), 100% orange juice, and 100% grape juice, tomato ketchup, coffee (prepared for drinking at 115 degrees Fahrenheit (46° C.), with one teaspoon of instant coffee per cup of water), extra virgin olive oil, 100 proof Vodka alcohol, and detergent solution (0.5% by weight of an unconcentrated

detergent mixed with water) for up to 24 hours. Similarly, 3 cubic centimeters (cc) of natural yellow mustard was placed on the four surfaces to be tested for 1 hour. The samples were allowed to stand for the specified time and then the surfaces were then sponge washed with water and dried with a clean cloth.

The sample to be tested was considered to have passed the test if there was no discoloration, stain or whitening that will not disperse with ordinary polishing. Any parts that come in contact with the chemical should not swell. If swelling was present, the tested part should be allowed to stand (in a lighted room) for 14 days and then rechecked for the same performance requirements as above.

### Detergent and Water Resistance of KCMA

After mixing components of the solvent based acid-curing coating composition according to the present application, the resulting mixture was applied to a wood substrate at a wet film thickness of 100-150 microns at 85% humidity and cured at room temperature (about 21° C.) for 24 hours, thus forming the samples to be tested.

The central region of the sample to be tested was measured. Use #8 cellulose sponge or equivalent. Use a full length sponge, with the exception that if the test sample was frame door, cut the sponge length to 2″ shorter than the shoulder length of the door rail (sponge should be 1″ away from frame joints). The detergent solution shall be an aqueous solution of 0.5% by weight un-concentrated detergent (Un-concentrated detergent=18.9 ml per gallon of water or 5.0 ml per liter of water).

Level through and fill with the detergent solution to ½ inch below top level of sponge. The sample to be tested was placed on the sponge and allowed to stand for 24 hours.

The sample to be tested was considered to have passed the test if the sample did not delaminate or swell and did not show discoloration and blistering, cracking, whitening or other signs of film failure. If failure occurred during initial inspection, the sample was allowed to stand for 14 days and then rechecked for the same performance requirements as above.

### High/Low Humidity Test of MBCI

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

Condition high humidity chamber to 120° F. (49° C.) and 70% RH. Condition low humidity chamber to 110° F. (43° C.) and 20% RH. Allow the test sample to set at room temperature (about 21° C.) and humidity (30% to 50% relative humidity) for 24 hours. Evaluate the samples for defects prior to testing. Place the sample in a high humidity chamber and allow the sample to remain in the chamber for 24 hours. Remove and allow the sample to set at room temperature (about 21° C.) and ambient humidity (30% to 50% relative humidity) for 24 hours. Place the sample in a low humidity chamber and allow the sample to remain in the chamber for 24 hours. Remove and allow the sample to stand at room temperature (about 21° C.) and ambient humidity (30% to 50% relative humidity) for 24 hours. The above steps were repeated for a total of 2 cycles (10 days of testing).

The samples to be tested were considered to have passed the test if there was no glue line failure, open joints, cracks or discoloration in the finish of the sample to be tested.

### Heat Resistance Test of MBCI

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

A test oven was preheated to the specified temperature (170° F. or 77° C.). Distribute the samples face up in the test oven evenly. Keep the sample in the oven for the specified test time (1 hour). Remove and allow the sample to return to room temperature (about 21° C.).

The samples to be tested were considered to have passed the test if there was no change in color, blistering, cracking or peeling of samples.

### Cold Resistance Test of MBCI

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

A test refrigerator was adjusted to −5° F.±5° F. and the samples were evenly distributed in the test refrigerator. 24 hours later the samples were removed and allowed to return to room temperature (about 21° C.).

The samples to be tested were considered to have passed the test if there was no change in color, blistering, cracking or peeling of samples.

### Cross Hatch Test of MBCI

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

Select areas on the sample to be tested that are free of defects and minor surface imperfections. Place the sample on a firm base and using a cross hatch tool, make first cut 1 and ½ inches long, then make a second cut at 90 degrees to and centered on the original cut to create a grid pattern in the film. Apply just enough pressure on the tool to cut through the finish. Brush the area clean and inspect the cuts making sure that the cuts were through finish. Remove 2 complete laps of pressure sensitive tape (polyester film/polyester non-woven tape with thermosetting rubber adhesive), remove an additional length of tape at a steady (that is not jerked) rate and cut a 3-inch (7.6 cm) length of tape. Place center of tape over cuts, smooth over with finger and rub down with a #2 eraser. Within 90 seconds±30 seconds of application, remove tape quickly (without jerking) as close to 180 degrees as possible. Examine the removed area using a magnifier and rate adhesion according to scale listed under the desired performance standard and repeat the test at different locations of the sample.

If the adhesion of the sample to be tested was greater than ≥3B, the sample to be tested was considered to have passed the test.

### Accelerated UV/Heat Exposure Test for MBCI

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

Using a QUV machine, a UVA-351 bulb was used. Pre-regulate heat temperature of the QUV machine to 50° C. The surface of the sample to be tested shall age for 100 hours.

The sample to be tested was considered to have passed the test if the change in L* and b* values before and after aging did not exceed 1.00 and the change in a* value did not exceed 0.30.

### Profile and Joint Finish Adhesion Tape Test of MBCI

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

Select sample areas free of imperfections and minor surface defects on the joints, inside profile or outside profile of door or drawer front sample. Remove 2 complete laps of pressure sensitive tape (polyester film/polyester non-woven tape with thermosetting rubber adhesive). Remove an additional length of tape at a steady (that is not jerked) rate and cut a piece of at least 4 inches (10 cm) long.

Apply the tape: If testing profile, place center of the tape over the corner, making sure the tape will cover some of the face surface as well as the outside edge; if testing joint, place the tape parallel to the joint seam, making sure the seam is in the center of the tape and that the ends of the tape extend beyond the inside and outside profiles. Smooth the tape over with fingers and then rub down with a #2 eraser. Within 90 seconds±30 seconds of application, remove tape quickly (without jerking) as close to 180 degrees as possible. Repeat this test for all 4 joints, the outside profile of each rail and the inside profile of each rail (using a magnifying glass if needed) to meet the required performance standard.

If no finish was removed from the area to be tested, the sample to be tested was considered to have passed this test.

### Wet Towel Finish Test of MBCI

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

The prepared sample to be tested was placed in a pan. Make sure the edges were up. To maintain a good edge for comparison, place the cotton cloth over only half of the panel. Pour 160 degree F. (71° C.) water over the cloth until the cloth was saturated (1-2 cups or about 200-500 ml). Allow to sit overnight (at least 20 hours) and evaluate for failure. If no failure was found, repeat steps 2 through 4 (no more than two applications). After standing overnight (at least 20 hours), evaluate the second application for failure. If no failure was found, place in a 150 degree F. (65° C.) oven for 2 hours, remove from the oven and evaluate again. The sample to be tested was considered to have passed this test if there was no visible discoloration and no signs of blistering, cracking, adhesion or other film failure.

### Mar Test of MBCI

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

Testing was performed using a Balanced Beam Scrape Adhesion (using ASTM D2197) and Mar Tester (using ASTM D5178). A sample was considered to pass the test if it was evaluated as to have a rating greater than or equal to 5. An exception was the DA Vanity program. In this case, the sample to be tested was considered to have passed the test if it was evaluated as to have a rating greater than or equal to 2.

### High Temperature Dark Storage Yellowing Test

After mixing components of the solvent-borne acid-curing coating composition according to the present application, the resulting mixture was applied to a wood substrate at a wet film thickness of 100-150 microns at 85% humidity and cured at room temperature (about 21° C.) for 24 hours to form the samples to be tested.

The L*, a* and b* values of initial test samples were tested. Then, the samples were kept in an oven at 60° C. for one week and two weeks, and then the L*, a* and b* values of the aged samples were tested.

Next, the color difference values of the coatings before and after aging were obtained using the following equation.

$$Δ E = {[ {( Δ {L}^{*} )}^{2} + {( Δ {a}^{*} )}^{2} + {( Δ {b}^{*} )}^{2} ]}^{1 / 2}$$

Where ΔL=L sample − L standard (brightness difference); Δa=a sample − a standard (red/green difference); Δb=b sample − b standard (yellow/blue difference);
ΔE indicates the magnitude of the total color difference,
in which larger ΔL indicates whitish, smaller ΔL indicates blackish; larger Δa indicates reddish, smaller Δa indicates greenish; and larger Δb indicates yellowish, smaller Δb indicates blueish.

### Raw Material

Hydroxyl-functional resin: hydroxyl-functional alkyd resin, hydroxyl value: 115 mg KOH/g;
Amino resins: fast drying iso-butylated urea-melamine-formaldehyde resin;
Di-amino-functional silane: aminoethylaminopropyltrimethoxysilane;
Epoxy-functional silane: bifunctional organosilane, 3-glycidyloxypropyltrimethoxysilane;
Acidic catalysts: general industrial product.
Pigments: general industrial product.
Solvents: general industrial product.

### Coating Compositions

As shown in Table 1, the components in the amounts shown were mixed so as to form a film-forming composition of solvent-borne acid-curing coating composition, and then a silane additive was added to the resulting film-forming composition so as to obtain the final solvent-borne acid-curing coating composition, wherein Example 1 is a solvent-borne acid-curing coating composition comprising a lower amount of amino-functional silane; Example 2 is a solvent-borne acid-curing coating composition comprising a larger amount of amino-functional silane; Comparative Example 1 is a solvent-borne acid-curing coating composition comprising a lower amount of epoxy-functional silane; Comparative Example 2 is a solvent-borne acid-curing coating composition comprising a larger amount of epoxy-functional silane; and Control 1 is a solvent-borne acid-curing coating composition that does not contain any silane.

The above coating compositions of Example 1, Example 2, Comparative Example 1, Comparative Example 2 and Control 1 were sprayed onto the surface of a support substrate at a wet coating thickness of 150 microns at 85% humidity. The resulting coatings were dried at room temperature (about 21° C.) for 24 hours. The blushing and gloss of the coatings were then determined according to the method described in the previous test section, and the results were summarized in Table 1 below.

TABLE 1
Components of solvent-borne acid-curing coating compositions and their amount

| | | | Comparative | Comparative | |
|---|---|---|---|---|---|
| Raw material/g | Example 1 | Example 2 | Example 1 | Example 2 | Control 1 |
| Hydroxyl-functional resin | 28 | 28 | 28 | 28 | 28 |
| Amino resin | 25 | 25 | 25 | 25 | 25 |
| Acid catalyst | 3 | 3 | 3 | 3 | 3 |
| Pigment | 25 | 25 | 25 | 25 | 25 |
| Solvent | 16 | 16 | 16 | 16 | 16 |
| Other additional additive | 3 | 3 | 3 | 3 | 3 |
| Total | 100 | 100 | 100 | 100 | 100 |
| Epoxy-functional silane | — | — | 0.5 | 1.0 | — |
| Amino-functional silane | 0.5 | 1.8 | — | — | — |
| Total | 100.5 | 101.8 | 100.5 | 101.0 | 100 |

Coating performance

| | | | | | |
|---|---|---|---|---|---|
| Blushing (ASTM D1735) | No | No | Yes | Yes | Yes |
| Glossiness@60° | 11-13 | 11-13 | 11-13/3-4 | 11-13/3-4 | 11-13/3-4 |
| Normal area/blushing | | | | | |
| area (ASTM D523) | | | | | |

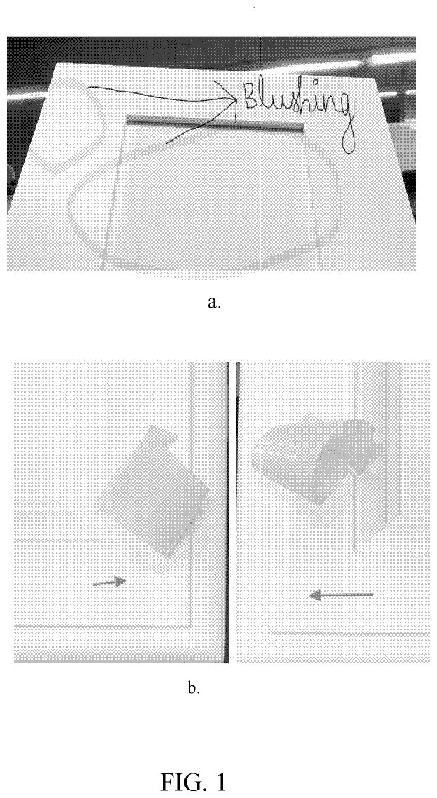

As can be seen from the results in Table 1, in the formulation of solvent-borne acid-curing coating compositions comprising the hydroxyl-functional resin, the amino compound and the acid catalyst, by adding a specific amount of the amino-functional silane, the issue of the above-mentioned acid-curing system being prone to blushing according to ASTM D1735 when applied under high humidity environments, even under extremely high humidity environments with a humidity of 85% or higher) may be specially solved. The resulting coating composition was not only substantially free of blushing upon film-forming under high humidity conditions, but also produced coatings with a high gloss. In contrast, the addition of epoxy-functional silane could not solve the blushing problem when applied under high humidity conditions, and the coating showed obvious blushing areas, and the blushing areas had significantly lower gloss compared to the normal areas, as shown in FIG. 1.

### Coating Performances of Coating Composition

The solvent-borne acid-curing coating compositions of Example 1 and Example 2, as formulated in Table 1 above, were sprayed onto the surface of a support substrate at a wet coating thickness of 150 microns at 85% humidity. The resulting coating was dried at room temperature (about 21° C.) for 24 hours. The coating properties were then measured according to the method described in the previous test section and the results were summarized in Table 2 below.

TABLE 2
Coating properties of solvent-borne
acid-curing coating compositions

| Coating properties | | Example 1 | Example 2 |
|---|---|---|---|
| shrinkage and heat resistance of KCMA | | pass | pass |
| cold and heat check resistance of KCMA | | pass | pass |
| chemical resistance of KCMA | | pass | pass |
| detergent and water resistance of KCMA | | pass | pass |
| high/low humidity testing of MBCI | | pass | pass |
| heat resistance testing of MBCI | | pass | pass |
| cold resistance testing of MBCI | | pass | pass |
| cross hatch test of MBCI | | 4B | >3B |
| accelerated UV/heat exposure test of MBCI/ | | pass/−0.34, | — |
| ΔL*, Δb*, Δa* | | 0.24, −0.03 | |
| profile and joint Finish adhesion tape testing | | pass | pass |
| of MBCI | | | |
| wet towel finish Test of MBCI | | pass | pass |
| Mar Test of MBCI | | pass/ | pass/ |
| | | grade 10 | grade 10 |
| high temperature dark | ΔE@ one week | 0.1806 | — |
| storage yellowing test | ΔE@ two weeks | 0.1921 | — |

As can be seen from the results in Table 2 above, the solvent-borne acid-curing coating compositions according to the present application passed one or more of shrinkage and heat resistance, cold and heat check resistance, chemical resistance, and detergent and water resistance as specified by the Cabinetry Association of America (KCMA), and further passed one or more of more harsh testing programs as specified by cabinet buyers such as MBCI-Master Brand, such as high/low humidity testing, heat resistance testing, cold resistance testing, cross hatch test, accelerated UV/heat exposure test, profile and joint Finish adhesion tape testing, wet towel finish Test, Mar Test, and high temperature dark storage yellowing test. As a result, the coatings formed by the solvent-borne acid-curing coating compositions of the present application had significantly better coating performance.

### EMBODIMENTS

Embodiment 1: A solvent-borne acid-curing coating composition comprising: at least one film-forming composition, the at least one film-forming composition comprising at least one hydroxyl functional resin, at least one amino resin, and at least one acid catalyst, wherein the solvent-borne coating composition further includes at least one amino-functional silane.

Embodiment 2: An embodiment of Embodiment 1, wherein the coating composition further comprises, relative to the total weight of the film-forming composition, 0.2-2% by weight of the at least one amino-functional silane.

Embodiment 3: An embodiment of any of Embodiments 1 or 2, wherein the at least one amino-functional silane has the structural formula described in the following formula (1):

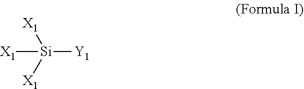

in which each X₁ is independently —Cl, —OCH₃, —OCH₂CH₃, —OC₂H₄OCH₃, —OSi(CH₃)₃, or —OCOCH₃; and Y₁ is an alkyl group substituted with —NH₂.

Embodiment 4: An embodiment of any of Embodiments 1 or 2, wherein the at least one amino-functional silane has the structural formula described in the following formula (2):

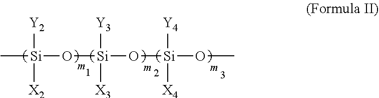

in which each of X₂, X₃ and X₄ is independently —Cl, —OCH₃, —OCH₂CH₃, —OC₂H₄OCH₃, —OSi(CH₃)₃, —OCOCH₃, —H, —CH₃, —C₂H₅, and —OH with the proviso that at least one of X₂, X₃ and X₄ is not —H, —CH₃, —C₂H₅, or —OH; at least one of Y₂, Y₃ and Y₄ is an alkyl group substituted with —NH₂; and each of m_{1,} m₂ and m₃ independently is from 0 to 200, with the proviso that at least one of m_{1,} m₂ and m₃ is not 0.

Embodiment 5: An embodiment of Embodiment 4, wherein the at least one amino-functional silane is diamino-functional.

Embodiment 6: An embodiment of any of Embodiments 1 or 2, wherein the at least one amino resin is a reaction product of at least one aldehyde and at least one amino compound selected from the group comprising melamine, urea, benzomelamine, methylmelamine, or a combination thereof.

Embodiment 7: An embodiment of Embodiment 6, wherein the at least one amino resin is etherified, preferably with n-butanol, isobutanol, methanol, or a combination thereof.

Embodiment 8: An embodiment of any of Embodiments 1 or 2, wherein the at least one hydroxyl-functional resin has a hydroxyl value in the range of 50 to 250 mg KOH/g according to ISO 4629.

Embodiment 9: An embodiment of any of Embodiments 1 or 2, wherein the at least one hydroxyl-functional resin comprises at least one alkyd resin, at least one acrylic resin, or a combination thereof, and preferably comprises at least one alkyd resin.

Embodiment 10: An embodiment of any of Embodiments 1 or 2, wherein the at least one acid catalyst is selected from the group comprising p-toluenesulfonic acid, benzenesulfonic acid, methanesulfonic acid, dinonylnaphthalenesulfonic acid, dinonylnaphthalenedisulfonic acid, dodecylbenzenesulfonic acid, oxalic acid, maleic acid, phthalic acid, acrylic acid, mono(di)alkyl phosphate, phosphoric acid, mono(di)alkyl pyrophosphate, or a combination thereof.

Embodiment 11: An embodiment of any of Embodiments 1 or 2, wherein the at least one film-forming composition comprises relative to the total weight of the at least one film-forming composition, 20-69% by weight of the at least one hydroxyl functional resin; 20-50% by weight of the at least one amino resin; 0.1-10% by weight of the at least one acid catalyst; 0.1-20% by weight of a solvent; and 0-30% by weight of additional additives, the additional additives including at least one pigment, at least one filler, at least one anti-settling agent, at least one thickener, at least one dispersant, at least one wetting agent, at least one film forming aid, at least one coupling agent, at least one bactericide, at least one antifungal agent, or any combination thereof.

Embodiment 12: An embodiment of any of Embodiments 1 to 11, wherein after the solvent-borne acid-curing coating composition is applied to a substrate and cured at a humidity of 85% or higher and ambient temperature, the resulting coating is substantially free of blushing according to ASTM D1735.

Embodiment 13: An embodiment of any of Embodiments 1 to 11, wherein after the solvent-borne acid-curing coating composition is applied to a substrate and cured at a humidity of 85% or higher and ambient temperature, the resulting coating has a gloss in the range of 11-13 sheen at 60° according to ASTM D523.

Embodiment 14: An article comprising a substrate having at least one major surface; and a coating at least partially applied directly or indirectly on the at least one major surface of the substrate, wherein the coating is formed by the solvent-borne acid-curing coating composition according to any one of Embodiments 1-13.

Embodiment 15: An embodiment of Embodiment 14, wherein the substrate is selected from wood, wood composite, paper, metal, plastic, fabric, ceramic, cementious material, or any combination thereof.

While the application has been described with respect to a number of embodiments and examples, those skilled in the art, having benefit of this application, will appreciate that other embodiments can be devised which do not depart from the scope and spirit of the application as disclosed herein.

What is claimed is:

1. A solvent-borne acid-curing coating composition comprising
at least one film-forming composition, the at least one film-forming composition comprising at least one hydroxyl functional resin, at least one amino resin, and at least one acid catalyst,
wherein the solvent-borne coating composition further includes at least one amino-functional silane.

2. The solvent-borne acid-curing coating composition according to claim 1, wherein the coating composition further comprises, relative to the total weight of the film-forming composition, 0.2-2% by weight of the at least one amino-functional silane.

3. The solvent-borne acid-curing coating composition according to claim 1, wherein the at least one amino-functional silane has the structural formula described in the following formula (1): 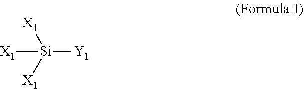
in which
each X₁ is independently —Cl, —OCH₃, —OCH₂CH₃, —OC₂H₄OCH₃, —OSi(CH₃)₃, or —OCOCH₃; and
Y₁ is an alkyl group substituted with —NH₂.

4. The solvent-borne acid-curing coating composition according to claim 1, wherein the at least one amino-functional silane has the structural formula described in the following formula (2): 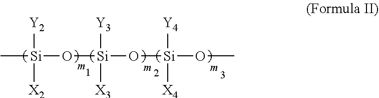
in which
each of X₂, X₃ and X₄ is independently —Cl, —OCH₃, —OCH₂CH₃, —OC₂H₄OCH₃, —OSi(CH₃)₃, —OCOCH₃, —H, —CH₃, —C₂H₅, and —OH with the proviso that at least one of X₂, X₃ and X₄ is not —H, —CH₃, —C₂H₅, or —OH;
at least one of Y₂, Y₃ and Y₄ is an alkyl group substituted with —NH₂; and
each of m_{1,} m₂ and m₃ independently is from 0 to 200, with the proviso that at least one of m_{1,} m₂ and m₃ is not 0.

5. The solvent-borne acid-curing coating composition of claim 4, wherein the at least one amino-functional silane is diamino-functional.

6. The solvent-borne acid-curing coating composition according to claim 1, wherein the at least one amino resin is a reaction product of at least one aldehyde and at least one amino compound selected from the group comprising melamine, urea, benzomelamine, methylmelamine, or a combination thereof.

7. The solvent-borne acid-curing coating composition according to claim 6, wherein the at least one amino resin is etherified, preferably with n-butanol, isobutanol, methanol, or a combination thereof.

8. The solvent-borne acid-curing coating composition according to claim 1, wherein the at least one hydroxyl-functional resin has a hydroxyl value in the range of 50 to 250 mg KOH/g according to ISO 4629.

9. The solvent-borne acid-curing coating composition according to claim 1, wherein the at least one hydroxyl-functional resin comprises at least one alkyd resin, at least one acrylic resin, or a combination thereof, and preferably comprises at least one alkyd resin.

10. The solvent-borne acid-curing coating composition according to claim 1, wherein the at least one acid catalyst is selected from the group comprising p-toluenesulfonic acid, benzenesulfonic acid, methanesulfonic acid, dinonylnaphthalenesulfonic acid, dinonylnaphthalenedisulfonic acid, dodecylbenzenesulfonic acid, oxalic acid, maleic acid, phthalic acid, acrylic acid, mono(di)alkyl phosphate, phosphoric acid, mono(di)alkyl pyrophosphate, or a combination thereof.

11. The solvent-borne acid-curing coating composition according to claim 1, wherein the at least one film-forming composition comprises relative to the total weight of the at least one film-forming composition,
20-69% by weight of the at least one hydroxyl functional resin;
20-50% by weight of the at least one amino resin;
0.1-10% by weight of the at least one acid catalyst;
0.1-20% by weight of a solvent; and
0-30% by weight of additional additives, the additional additives including at least one pigment, at least one filler, at least one anti-settling agent, at least one thickener, at least one dispersant, at least one wetting agent, at least one film forming aid, at least one coupling agent, at least one bactericide, at least one antifungal agent, or any combination thereof.

12. The solvent-borne acid-curing coating composition according to claim 1, wherein after the solvent-borne acid-curing coating composition is applied to a substrate and cured at a humidity of 85% or higher and ambient temperature, the resulting coating is substantially free of blushing according to ASTM D1735.

13. The solvent-borne acid-curing coating composition according to claim 1, wherein after the solvent-borne acid-curing coating composition is applied to a substrate and cured at a humidity of 85% or higher and ambient temperature, the resulting coating has a gloss in the range of 11-13 sheen at 60° according to ASTM D523.

14. An article comprising
a substrate having at least one major surface; and
a coating at least partially applied directly or indirectly on the at least one major surface of the substrate,
wherein the coating is formed by the solvent-borne acid-curing coating composition according to claim 1.

15. The article of claim 14, wherein the substrate is selected from wood, wood composite, paper, metal, plastic, fabric, ceramic, cementious material, or any combination thereof.
